(19) United States
(12) Patent Application Publication
(10) Pub. No.: US 2026/0214409 A1
(43) Pub. Date: Jul. 23, 2026

(54) APPARATUS AND METHOD FOR AUDIO SIGNAL PROCESSING TO BENEFICIALLY MODIFY THE COHERENT PORTIONS OF AUDIO SIGNALS

(71) Applicant: FRAUNHOFER-GESELLSCHAFT ZUR FOERDERUNG DER ANGEWANDTEN FORSCHUNG E.V., Muenchen (DE)

(72) Inventors: Pablo PANTER, Erlangen (DE); Andreas WALTHER, Erlangen (DE); Hanne STENZEL, Erlangen (DE); Julien HAIBACH, Erlangen (DE); Julian KLAPP, Erlangen (DE)

(21) Appl. No.: 19/448,594

(22) Filed: Jan. 14, 2026

Related U.S. Application Data
(63) Continuation of application No. PCT/EP2024/070087, filed on Jul. 16, 2024.

(30) Foreign Application Priority Data
Jul. 18, 2023 (EP) EP23186255.8

(51) Int. Cl. H04S 7/00; H04S 3/00

(52) U.S. Cl. CPC H04S 7/307; H04S 3/008; H04S 2400/01

(57) ABSTRACT

An apparatus for audio signal processing has a signal separator for separating each of at least two audio input signals into a first and a second signal portion, a signal processor for obtaining a phase-aligned signal portion of each audio input signal from the first signal portion of each audio input signal by modifying the first signal portion of at least one audio input signal; the signal processor configured to modify the first signal portion of said at least one audio input signal by phase aligning the first signal portion of said at least one audio input signal with the first signal portion of at least another audio input signal, and a combiner for combining the phase-aligned signal portion and the second signal portion of each audio input signal to obtain at least two audio output signals.

### CROSS-REFERENCE TO RELATED APPLICATIONS

This application is a continuation of copending International Application No. PCT/EP2024/070087, filed Jul. 16, 2024, which is incorporated herein by reference in its entirety, and additionally claims priority from European Application No. EP23186255.8, filed Jul. 18, 2023, which is also incorporated herein by reference in its entirety.

### TECHNICAL FIELD

The present invention relates to audio processing, to an apparatus and a method for audio signal processing to beneficially modify the coherent portions of audio signals and, more particularly, to (pre) processing to beneficially modify the coherent portions of audio signals.

### BACKGROUND OF THE INVENTION

In recent years, compact audio devices like soundbars and smart speakers have become increasingly popular. In contrast to traditional loudspeaker setups, where a dedicated loudspeaker is used to reproduce the content of a single input channel, these compact reproduction devices usually feature only a limited number of loudspeakers (“limited number of loudspeakers” may, e.g., mean “a single device with a limited number of drivers”). The simplest smart speakers consist of only a single full-range driver for audio playback.

To be able to reproduce or at least mimic a reproduction of the spatial impression that is intended by the original content signal, smart speakers or soundbars with more than one loudspeaker driver often include spatial audio processing that makes use of either acoustical or psychoacoustical means to evoke a spatial impression.

The most common input signal type found in consumer environments today is still two-channel stereo content, while the amount of surround content (e.g. 5.1 or 7.1) and also immersive content featuring height channels (e.g. 5.1+4 or 7.1+4), Ambisonics signals of different order, and object based audio content is continuously increasing.

To be able to reproduce such multi-channel signals over the aforementioned consumer playback devices, the signals of different channels have to be combined at some point in the processing and are subsequently reproduced using a limited number of loudspeakers.

During content creation, gain differences, delay differences, and phase differences between signal components on different channels or objects are exploited in audio recording, mixing, and rendering to evoke specific perceptual effects.

If such content is reproduced using the described compact consumer devices rather than the intended playback setup, a combination of such signals for playback over compact devices can result in a deviation from the original signal(s) and such, a deviation from the evoked perception.

One of the most critical cases that can occur (and which is prevented by the described inventive method) results in the complete cancelation of signal content (that may be the complete signal, as well as only parts or components of a signal or of signals—this depends on the specifics of the content), which means they would not be audible at all, which would be a drastic change in the content.

In the following exemplification (use-case description), we exemplarily use the simplest case reproduction device consisting of a single mono smart speaker with only a single loudspeaker driver which is fed by a two-channel input signal.

FIG. 2 illustrates a device-specific processing. In such a scenario, the two input signals are combined to be played back over the single driver. In this case, signal cancelation will occur when the two input signals carry phase inverted signals, or signals with phase inverted portions, those would be canceled out when the signals are combined to be played back over the single driver. Such, the signal content carried by the phase inverted signal portion will be lost in reproduction.

This is not desirable, since often phase inverted signal portions are included in productions for specific reasons. One of them being to evoke a specific perceptual effect that would be audible when the two inverted signals would be played back over two separate loudspeakers.

While this effect is not achievable by playing back the signals only over a single loudspeaker, it is still desirable to preserve the content of these signals in the reproduced sound.

The inventive method, which will be described in the following, avoids the loss of such signal parts, so that all of the content is audible.

FIG. 3 illustrates a second scenario, where a device is considered with multi-channel input, two loudspeakers, and spatial processing, making use of a dipole processing, which may also be referred to as gradient processing. The aim of gradient processing is to apply a signal to multiple loudspeakers while inverting their phase to generate a specific directivity pattern of the playback device.

In FIG. 3, the inputs In_1 to In_5 could correspond to the left, center, right, left_surround, and right_surround channels of a 5.0 surround sound signal.

The left signal (In_1) is reproduced by the left driver of the device.

The right channel (In_3) is reproduced by the right driver of the device.

The center channel (In_2) is split and reproduced by both loudspeakers of the device.

The surround channels (In_4 and In_5) are fed to both loudspeakers of the device in a dipole-fashion. This is indicated by the phase inversion (multiplication by −1) that is applied to the split signal which is fed to one of the drivers. Note that the phase inversion is applied to different loudspeakers for the two signals.

The processing applied to the input channels in such devices usually incorporates more steps and is more complex. For example, the center signal will have an attenuation applied to avoid that it is louder than the left and right signals when played back over two loudspeakers.

Also, for the surround channels, additional processing can be applied, and the dipole processing can have further parameters such as gain and delay applied to the two input signals to control the achieved directional effect.

For the purpose of example, FIG. 3 highlights primarily the factor, which is the phase inversion (multiplication with −1) that is applied to the signals. Similar processing is also applied in devices with more than two loudspeakers to achieve a directionally reproduction or a specific directivity pattern.

Different approaches and realizations are known from the literature.

If the input signals to such a differential processing carry positively correlated (see below) signal portions, these would be canceled out in the reproduction. An example where this would happen in the given example is, if a signal is panned in between the two surround channels.

### SUMMARY

According to an embodiment, an apparatus for audio signal processing may have a signal separator for separating each of at least two audio input signals into a first signal portion and into a second signal portion. Moreover, the apparatus comprises a signal processor for obtaining a phase-aligned signal portion of each of the at least two audio input signals from the first signal portion of each of the at least two audio input signals by modifying the first signal portion of at least one audio input signal of the at least two audio input signals; wherein the signal processor is configured to modify the first signal portion of said at least one audio input signal by phase aligning the first signal portion of said at least one audio input signal with the first signal portion of at least another audio input signal of the at least two audio input signals. Furthermore, the apparatus comprises a combiner for combining the phase-aligned signal portion and the second signal portion of each of the at least two audio input signals to obtain at least two audio output signals.

According to another embodiment, a method for audio signal processing may have the steps of:
Separating each of at least two audio input signals into a first signal portion and into a second signal portion.
Obtaining a phase-aligned signal portion of each of the at least two audio input signals from the first signal portion of each of the at least two audio input signals by modifying the first signal portion of at least one audio input signal of the at least two audio input signals; wherein modifying the first signal portion of said at least one audio input signal is conducted by phase aligning the first signal portion of said at least one audio input signal with the first signal portion of at least another audio input signal of the at least two audio input signals. And:
Combining the phase-aligned signal portion and the second signal portion of each of the at least two audio input signals to obtain at least two audio output signals.

Another embodiment may have a computer program for implementing the above-described method when being executed on a computer or signal processor is provided.

Some embodiments relate to a processor that processes audio input signals such that they are conditioned in a way to avoid detrimental effects that would otherwise occur in subsequent processing.

Advantageous embodiments relate to the field of audio reproduction. While reproduction scenarios are chosen as example applications in the following, the processing could also be applied to other contexts such as content production, audio coding, transmission of audio signals, etc.

Embodiments avoid the loss of positively correlated signal parts, that would be canceled out in the reproduction of known systems by a differential processing.

### BRIEF DESCRIPTION OF THE DRAWINGS

In the following, embodiments of the present invention are described in more detail with reference to the figures, in which:

FIG. 1 illustrates an apparatus for audio signal processing according to an embodiment;

FIG. 2 illustrates a device-specific processing wherein, two input signals are combined to be played back over the single driver;

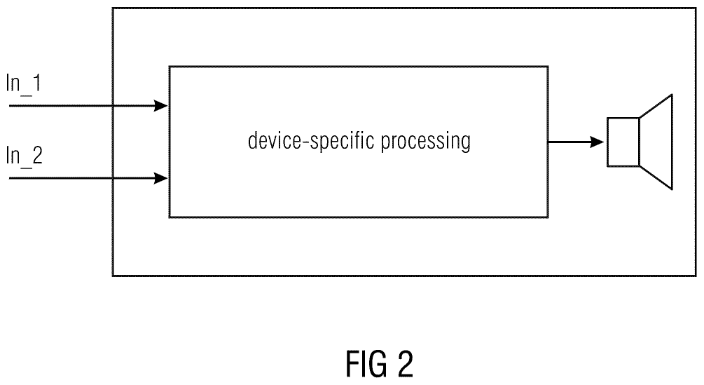

FIG. 3 illustrates a second scenario, where a device is considered with multi-channel input, two loudspeakers, and spatial processing, making use of a dipole processing;

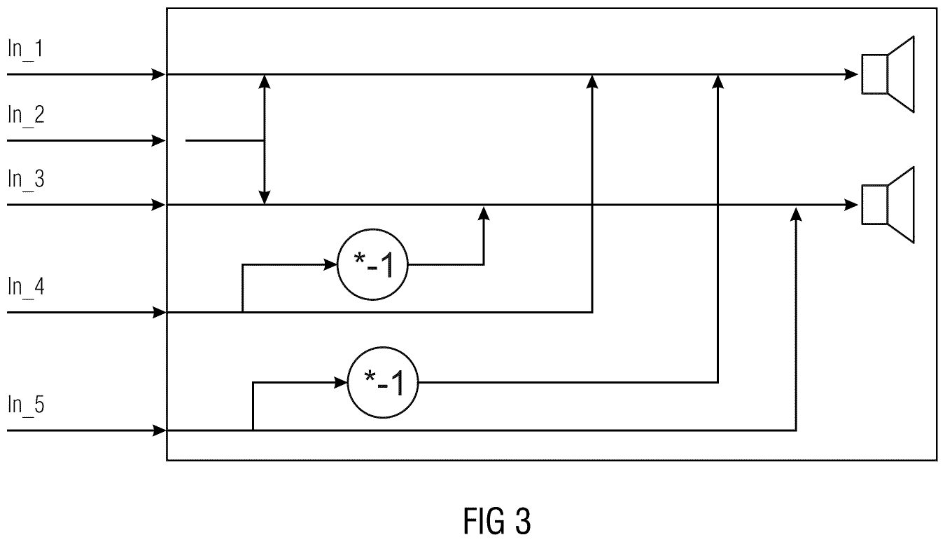

FIG. 4 illustrates a scenario, wherein the processor receives two audio signals at its input, processes these, and outputs two audio signals;

FIG. 5 illustrates more details of a processing of audio signals according to an embodiment;

FIG. 6 illustrates a diagram according to an embodiment, wherein the weighting factor is decreasing with increasing frequency;

FIG. 7 illustrates a separation function according to an embodiment for different threshold values;

FIG. 8 illustrates a plot which depicts an example mapping between a correlation indicator and a correlation adaptive time constant according to an embodiment;

FIG. 9 illustrates an example for a smoothing of the attack and release times according to an embodiment;

FIG. 10 illustrates an example application according to an embodiment with a smart speaker;

FIG. 11 illustrates a scenario according to an embodiment, in which an audio signal is sent from a source device to multiple playback devices;

FIG. 12 illustrates a device according to an embodiment with two loudspeaker drivers in a single enclosure;

FIG. 13 illustrates an example application of a processing in a soundbar device that according to an embodiment;

FIG. 14 illustrates an embodiment for multiple input channels by applying the processing according to embodiments multiple times in a parallel fashion;

FIG. 15 illustrates an embodiment for multiple input channels by applying the processing according to embodiments multiple times in a concatenated/sequential fashion;

FIG. 16 illustrates an embodiment for multiple input channels by applying the processing according to embodiments multiple times in a mixture of the parallel fashion of FIG. 14 and of the concatenated/sequential fashion of FIG. 15;

FIG. 17 schematically illustrates an embodiment for multiple input channels by extending the processor to multiple inputs and adding means to select, based on selection parameters or control parameters, the two input channels that should be processed;

FIG. 18 schematically illustrates an embodiment for multiple input channels by calculating the coherence and correlation between the multiple channels and different combinations thereof, and modifying the processor such that the phase alignment happens from one channel to a multiple of the other channels;

FIG. 19 illustrates an embodiment without the power compensation; and

FIG. 20 illustrates a translation function according to an embodiment.

### DETAILED DESCRIPTION OF THE INVENTION

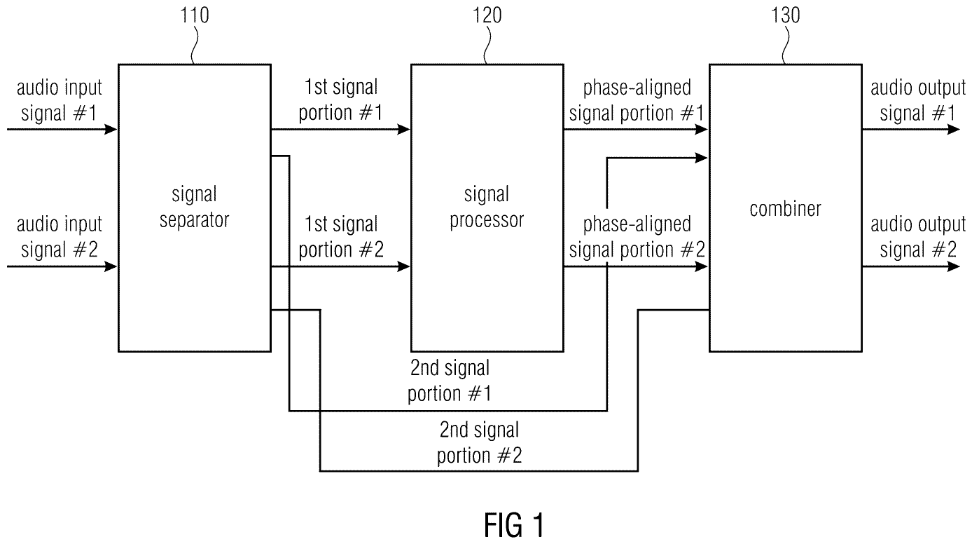

FIG. 1 illustrates an apparatus for audio signal processing according to an embodiment.

The apparatus comprises a signal separator 110 for separating each of at least two audio input signals into a first signal portion and into a second signal portion.

Moreover, the apparatus comprises a signal processor 120 for obtaining a phase-aligned signal portion of each of the at least two audio input signals from the first signal portion of each of the at least two audio input signals by modifying the first signal portion of at least one audio input signal of the at least two audio input signals; wherein the signal processor 120 is configured to modify the first signal portion of said at least one audio input signal by phase aligning the first signal portion of said at least one audio input signal with the first signal portion of at least another audio input signal of the at least two audio input signals.

Furthermore, the apparatus comprises a combiner 130 for combining the phase-aligned signal portion and the second signal portion of each of the at least two audio input signals to obtain at least two audio output signals.

According to an embodiment, the signal separator 110 may, e.g., be configured to separate each of the at least two audio input signals into the first signal portion and into the second signal portion depending on a coherence and/or a correlation.

In an embodiment, the signal separator 110 may, e.g., be configured to separate each of the at least two audio input signals into the first signal portion and into the second signal portion depending on a coherence and/or a correlation of the first signal portion and a signal portion of one or more other audio input signals of the at least two audio input signals.

According to an embodiment, the signal separator 110 may, e.g., be configured to separate each of at least two audio input signals into the first signal portion (e.g., a coherent signal portion) and into the second signal portion (e.g., a non-coherent signal portion), such that the first signal portion may, e.g., be coherent with a signal portion of one or more other audio input signals of the at least two audio input signals.

In an embodiment, to obtain the phase-aligned signal portion of each of the at least two audio input signals, the signal processor 120 may, e.g., be configured to modify the first signal portion of said at least one audio input signal, and may, e.g., be configured to not modify the first signal portion of said at least one other audio input signal.

According to an embodiment, to obtain the phase-aligned signal portion of each of the at least two audio input signals, the signal processor 120 may, e.g., be configured to modify the first signal portion of each of the at least two audio input signals.

In an embodiment, the at least two audio input signals may, e.g., be exactly two audio input signals, said at least one audio input signal may, e.g., be exactly one audio input signal, said at least one other audio input signal may, e.g., be exactly one other audio input signal, and the at least two audio output signals may, e.g., be exactly two audio output signals.

According to an embodiment, the signal processor 120 may, e.g., be configured to phase align the first signal portion of said at least one audio input signal with the first signal portion of said at least one other audio input signal in the frequency domain.

In an embodiment, the signal processor 120 may, e.g., be configured to align a phase of at least one frequency band of the first signal portion of said at least one audio input signal with a phase of said at least one frequency band of the first signal portion of said at least one other audio input signal in the frequency domain.

According to an embodiment, the signal processor 120 may, e.g., be configured to align a phase of each of two or more frequency bands of the first signal portion of said at least one audio input signal with a phase of each of said two or more other frequency bands of the first signal portion of said at least one other audio input signal in the frequency domain.

In an embodiment, the apparatus further comprises a time-to-frequency transform unit for transforming the at least two audio input signals, being represented in a time domain, from the time domain to the frequency domain. The apparatus further comprises a frequency-to-time transform unit for transforming the at least two audio output signals, being represented in the frequency domain, from the frequency domain to the time domain.

According to an embodiment, the time-to-frequency transform unit may, e.g., be configured to conduct a short-time Fourier transform to transform the at least two audio input signals from the time domain to the frequency domain. The frequency-to-time transform unit may, e.g., be configured to conduct an inverse short-time Fourier transform to transform the at least two audio output signals from the frequency domain to the time domain.

In an embodiment, the signal processor 120 may, e.g., be configured to phase align the first signal portion of said at least one audio input signal with the first signal portion of said at least one other audio input signal such that in case of a negative correlation of the first signal portion of said at least one audio input signal and the first signal portion of said at least one other audio input signal, the phase-aligned signal portion of said at least one audio input signal and the phase-aligned signal portion of said at least one other audio input signal have a same phase after the phase aligning.

According to an embodiment, the signal processor 120 may, e.g., be configured to phase align the first signal portion of said at least one audio input signal with the first signal portion of said at least one other audio input signal such that in case of a positive correlation of the first signal portion of said at least one audio input signal and the first signal portion of said at least one other audio input signal, the phase-aligned signal portion of said at least one audio input signal and the phase-aligned signal portion of said at least one other audio input signal have an inverted phase after the phase aligning.

In an embodiment, the signal processor 120 may, e.g., be configured to phase align the first signal portion of said at least one audio input signal with the first signal portion of said at least one other audio input signal by copying the phase information of the first signal portion of said at least one other audio input signal to the first signal portion of said at least one audio input signal.

According to an embodiment, the signal processor 120 may, e.g., be configured to phase align the first signal portion of said at least one audio input signal with the first signal portion of said at least one other audio input signal by copying and inverting the phase information of the first signal portion of said at least one other audio input signal to the first signal portion of said at least one audio input signal.

In an embodiment, the signal processor 120 may, e.g., be configured to phase align the first signal portion of said at least one audio input signal with the first signal portion of said at least one other audio input signal without altering a magnitude of the first signal portion of said at least one audio input signal and without altering a magnitude of the first signal portion of said at least one other audio input signal.

According to an embodiment, the second signal portion of each of the at least two audio input signals may, e.g., be unmodified when being combined by the combiner 130.

In an embodiment, the at least two audio input signals may, e.g., comprise one or more audio channel signals and/or one or more audio object signals and/or one or more Ambisonics signals.

In an embodiment, the apparatus comprises a power compensator such that a total signal energy of the at least two audio output signals corresponds to a total signal energy of the at least two audio input signals; or such that a signal energy of one of the at least two audio output signals corresponds to a signal energy of one of the at least two audio input signals; or such that a signal energy of each of the at least two audio output signals corresponds to a signal energy of one of the at least two audio input signals.

According to an embodiment, the power compensator may, e.g., be configured to conduct power compensation per frequency bin or per frequency band.

In an embodiment, the signal separator 110 may, e.g., be configured to separate each audio input signal of at least two audio input signals into a first signal portion and into a second signal portion by applying a first mask value on a time-frequency bin of said audio input signal to obtain a time-frequency bin of the first signal portion, and by applying a second mask value that depends on the first mask value on said time-frequency bin of said audio input signal to obtain a time-frequency bin of the second signal portion.

According to an embodiment, the signal separator 110 may, e.g., be configured to apply a same first mask value on two or more time-frequency bins of a same frequency band of said audio input signal to obtain two or more time-frequency bins of the first signal portion for said same frequency band. And/or, the signal separator 110 may, e.g., be configured to apply a same second mask value on two or more time-frequency bins of a same frequency band of said audio input signal to obtain two or more time-frequency bins of the second signal portion for said same frequency band.

In an embodiment, the signal separator 110 may, e.g., be configured to separate each audio input signal of at least two audio input signals into a first signal portion and into a second signal portion by multiplying the first mask value and said time-frequency bin of said audio input signal to obtain a time-frequency bin of the first signal portion, and by multiplying the second mask value and said time-frequency bin of said audio input signal to obtain a time-frequency bin of the second signal portion, wherein the first mask value exhibits a value v1, with 0≤v1≤1, and wherein the second mask value v2=1−v1.

According to an embodiment, the signal separator 110 may, e.g., be configured to separate the coherent signal parts into a first signal portion and into a second signal portion of said audio input signal such that the first signal portion only comprises coherent signal parts of the at least two audio input signals which exhibit a potential cancellation (e.g., phase correct or, e.g., phase inverted) in sum which is greater than a threshold.

In an embodiment, the signal separator 110 may, e.g., be configured to update the first mask value and the second mask value for each of a plurality of time-frequency bins of said audio input signal such that the first signal portion only comprises the coherent signal parts of the at least two audio input signals which exhibit the potential cancellation in sum which is greater than the threshold.

According to an embodiment, the signal separator 110 may, e.g., be configured to separate each audio input signal of at least two audio input signals into a first signal portion and into a second signal portion depending on a coherence for each time-frequency bin of a plurality of time-frequency bins, wherein the coherence may, e.g., be averaged over time.

In an embodiment, the signal separator 110 may, e.g., be configured to determine the coherence for each time-frequency bin of the plurality of time-frequency bins depending on an auto-correlation for said time-frequency bin that may, e.g., be averaged over the time, and depending on a cross-correlation for said time-frequency bin that may, e.g., be averaged over time.

According to an embodiment, the signal separator 110 may, e.g., be configured to determine a frequency-dependent absolute cross spectrum phase, summarized into a single absolute cross spectrum phase value by a frequency dependent mean.

In an embodiment, the single frequency-dependent absolute cross spectrum phase value exhibiting a value of 0 indicates a positive correlation, the single frequency-dependent absolute cross spectrum phase value exhibiting a value of 0.5 indicates no correlation, and the single frequency-dependent absolute cross spectrum phase value exhibiting a value of 1 indicates a negative correlation.

According to an embodiment, the signal separator 110 may, e.g., be configured to separate each audio input signal of at least two audio input signals into a first signal portion and into a second signal portion by employing a separation function which depends on the coherence for a time-frequency bin of the plurality of time-frequency bins.

In an embodiment, the separation function separates a magnitude of a time-frequency bin into a coherent magnitude portion and into a non-coherent magnitude portion.

According to an embodiment, the separation function may, e.g., be frequency-dependent.

In an embodiment, the separation function depends on a signal property of at least one of the at least two audio input signals.

According to an embodiment, the separation function depends on a threshold value.

In an embodiment, the threshold value may, e.g., be frequency dependent, such that the signal separator 110 may, e.g., be configured to assign a greater magnitude portion to the first signal portion exhibiting a lower frequency compared to a magnitude portion assigned to the first signal portion exhibiting a higher frequency for a same coherence.

According to an embodiment, the apparatus comprises an interface for setting the threshold value.

In an embodiment, the interface may, e.g., be configured to set the threshold individually per frequency band or individually per time-frequency bin.

According to an embodiment, the signal separator 110 may, e.g., be configured to smooth the separation of the at least two audio input signals into the first signal portion and into the second signal portion over time.

In an embodiment, the signal separator 110 may, e.g., be configured to smooth the separation of the at least two audio input signals over time depending on an attack time which defines an adaptation of a separation mask when a coherence increases and/or depending on a release time which defines an adaptation of the separation mask when the coherence decreases.

According to an embodiment, the signal separator 110 may, e.g., be configured to employ a different attack time for signals with a positive correlation compared to signals with a negative correlation. And/or, the signal separator 110 may, e.g., be configured to employ a different release time for signals with a positive correlation compared to signals with a negative correlation.

In an embodiment, the signal separator 110 may, e.g., be configured to smooth a change of the attack time over time. And/or, the signal separator 110 may, e.g., be configured to smooth a change of the release time over time.

According to an embodiment, the signal separator 110 may, e.g., be configured to change the attack time only up to a first predetermined amount within a first predetermined time period; and/or wherein the signal separator 110 may, e.g., be configured to change the attack time only up to a second predetermined amount within a second predetermined time period. The second predetermined amount may, e.g., be equal to or different from the first predetermined amount; and wherein the second predetermined time period may, e.g., be equal to or different from the first predetermined time period.

In an embodiment, the apparatus may, e.g., be configured to only process particular frequency bands of the at least two audio input signals.

According to an embodiment, the apparatus may, e.g., be configured to only process particular signal parts of the at least two audio input signals which exhibit particular signal characteristics or which exhibit a particular property.

In an embodiment, the particular signal characteristics or the particular property of an audio input signal of the at least two audio input signals may, e.g., be at least one of:
a presence of speech,
a presence of vocal parts,
if said audio input signal is a center signal,
if said audio input signal, being a center signal, is received or is derived from other channels,
if said audio input signal is an ambient signal,
if said audio input signal is a channel signal,
if said audio input signal is an object signal,
if said audio input signal is an Ambisonics signal,
directional information for said audio input signal,
panning information for said audio input signal,
if said audio input signal comprises transient signal portions.

According to an embodiment, the signal separator 110 may, e.g., be configured to determine a correlation indicator in a time domain.

In an embodiment, the signal separator 110 may, e.g., be configured to calculate a frequency-dependent correlation indication in the time domain by employing a filterbank and by conducting correlation calculation for particular bands.

According to an embodiment, the apparatus further comprises a device-specific processing stage to generate a single loudspeaker output from the at least two audio output signals.

In an embodiment, the apparatus may, e.g., be configured to feed the at least two audio output signals into each loudspeaker of three or more loudspeakers.

According to an embodiment, the apparatus may, e.g., be configured to receive information on a loudspeaker setup. The apparatus may, e.g., be configured to bypass or to not bypass the processing conducted by the signal separator 110 and the signal processor 120 and the combiner 130 using the information on the loudspeaker setup.

In an embodiment, the apparatus further comprises a device-specific processing stage to generate two loudspeaker feeds for two loudspeakers from the at least two audio output signals using information on one or more capabilities of the two loudspeakers and/or information on a distance between the two loudspeakers.

According to an embodiment, the at least two audio input signals may, e.g., be at least three audio input signals.

In an embodiment, the apparatus may, e.g., be configured to process the at least three audio input signals by applying the processing of the signal separator 110, of the signal processor 120 and of the combiner 130 two or more times.

According to an embodiment, the apparatus may, e.g., be configured to apply the processing of the signal separator 110, of the signal processor 120 and of the combiner 130 two or more times in parallel and/or sequentially.

In an embodiment, the apparatus may, e.g., be configured to process the at least three audio input signals by extending the processor to multiple inputs and by employing means to select, depending on selection parameters or control parameters, two audio input signals of the three or more audio input signals that shall be processed.

According to an embodiment, the apparatus may, e.g., be configured to process the at least three audio input signals by calculating a coherence and a correlation between two or more pairs of the at least three signals and/or by calculating different combinations thereof, and the signal processor 120 may, e.g., be configured to conduct phase alignment by using a phase of a first signal portion of one audio input signal of the at least three audio input signals for two or more other audio input signals of the at least three audio input signals.

In an embodiment, the signal separator 110 may, e.g., be configured to separate the at least two audio input signals into the first signal portion and into the second signal portion further depending on gain differences and/or phase differences between the at least two signals.

According to an embodiment, the signal separator 110 may, e.g., be configured to only separate coherent signal parts of the at least two audio input signals with a degree of positive correlation being greater than a threshold into a first signal portion of the at least two audio input signals.

In an embodiment, the apparatus may, e.g., be configured to only process coherent signal parts of the at least two audio input signals with a degree of negative correlation being smaller than a threshold.

According to an embodiment, the apparatus may, e.g., be configured to smooth calculated coherence values across frequencies.

In an embodiment, the apparatus may, e.g., be configured to smooth a separation factor along frequency.

According to an embodiment, the first signal portion may, e.g., be a coherent signal portion, and/or the second signal portion may, e.g., be a non-coherent signal portion.

In the following, particular embodiments of the present invention are described.

The inventive method describes a processor that accepts at its input two audio signals.

The signals are analyzed and processed such as to prevent detrimental effects in a potential subsequent processing or potential subsequent processing steps.

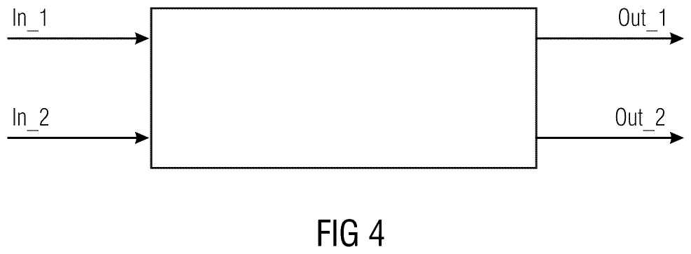

FIG. 4 illustrates a scenario, wherein the processor receives two audio signals at its input, processes these, and outputs two audio signals.

In an advantageous embodiment as outlined in the following, an analysis of the similarity between two signals is used to distinguish the signal parts that would cause a detrimental effect from those that would not cause a detrimental effect. The similarity between the two signals is estimated based on correlation and coherence, as further outlined below.

The input signals are analyzed and the phase information of coherent parts is aligned.

This phase alignment of the coherent parts consists of a manipulation of the phase information of one of the two signals to match it with the phase of the other signal.

Two variants are possible:
1. To phase-align the two signals such that out-of-phase signals or signal parts will have the same phase after the processing.
2. To phase-align the two signals such that in-phase signals or signal parts will have inverted phase after the processing.

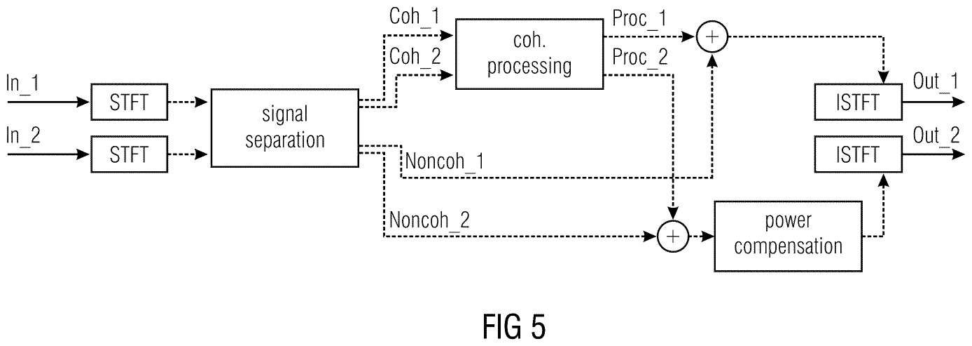

FIG. 5 illustrates more details of a processing of audio signals according to an embodiment.

In an advantageous embodiment, short consecutive parts of the signals are transformed into the frequency domain (Block STFT in FIG. 5, STFT=“Short-Time Fourier Transform”).

A separation process is performed on the input signals In_1 and In_2, which decomposes the input signals into parts that are coherent in both input signals (Coh_1 and Coh_2) and parts that are non-coherent (Noncoh_1 and Noncoh_2).

The coherent signal portions of one of the input signals (Coh_2) are processed such that the phase of these signal portions is aligned with the phase of Coh_1.

The magnitude of Coh_2 is not altered at this point in the processing.

For Coh_1, neither the magnitude nor the phase are altered.

Also the non-coherent parts of both input signals remain unaltered.

After the phase alignment, the coherent and non-coherent parts of the signals are combined.

The processed signal (Proc_2+Noncoh_2) is further processed such that the signal energy (time/frequency dependent, e.g. per frequency bin or frequency band) of signal Out_2 corresponds to the signal energy of In_2. The specific band type is not important. It could e.g. be octave-bands, ⅓ octave-bands, bands according to a bark scale etc. This footnote hold similarly for all other processing steps that are performed in the time/frequency domain. (This is not necessary for Out_1, since Out_1 corresponds to In_1).

While in an advantageous embodiment, this power compensation is performed, it is generally optional, since for many use cases the described phase-alignment does not result in huge energy changes in the processed signal compared to the original.

The output signals are then transformed back into the time domain.

In the following, individual processing steps of particular embodiments are described.

The signal separation is based on the calculation of an separation mask (M(f,s)) in time/frequency domain. The separation mask contains values between 0 and 1 for each frequency bin in each time frame. The ‘coherent’ spectra (Coh_1(f,s), Coh_2(f,s)) and ‘non-coherent’ spectra (Noncoh_1(f,s), Noncoh_2(f,s)) are obtained by multiplication of the input spectra with the separation mask in the following manner:

$$Coh\_ 1 ( f , s ) = In\_ 1 ( f , s ) M ( f , s )$$

$$Coh\_ 2 ( f , s ) = In\_ 2 ( f , s ) M ( f , s )$$

$$Noncoh\_ 1 ( f , s ) = In\_ 1 ( f , s ) ( 1 - M ( f , s ) )$$

$$Noncoh\_ 2 ( f , s ) = In\_ 2 ( f , s ) ( 1 - M ( f , s ) )$$

where f is an indication for the discrete frequency (bin), and s is an indication for discrete time (for a time frame).

The separation mask is calculated from the coherence between both input signals.

The coherence between the signals In_1 and In_2 can be calculated based on averaged auto-spectra and cross-spectra, where the averaging over time is controlled by a factor α (which determines the influence of the past signal behavior on the current estimate).

$${C}_{x y} ( f , s ) = \frac{{\vert {G}_{x y} ( f , s \vert}^{2}}{{G}_{x x} ( f , s ) {G}_{y y} ( f , s )}$$

$${G}_{x x} ( f , s ) = E [ X ( f , s ) {X}^{*} ( f , s ) ]$$

$${G}_{y y} ( f , s ) = E [ y ( f , s ) {Y}^{*} ( f , s ) ]$$

$${G}_{x y} ( f , s ) = E [ X ( f , s ) {Y}^{*} ( f , s ) ]$$

where E indicates an expectation, and * indicates the complex conjugate.

The averaged/expected value for a single frame s is obtained from the value of frame s and the averaged value of the previous frame:

$${G}_{x x} ( f , s ) = {G}_{x x} ( f , s - 1 ) ( 1 - α ) + X ( f , s ) {X}^{*} ( f , s ) α$$

Such, a coherence value for each time frequency bin is obtained.

The coherence can take on values between 0 and 1, where
A value of 0 indicates that there is no correlation between the two input signals, which means that they are independent from each other.
A coherence value of 1 indicates perfect positive or negative correlation. This indicates that the signals are either the same (coherence=1 and correlation=1), or they carry the same signal, but one is phase inverted in comparison to the other (coherence=1 and correlation=−1).

(The terms angle and phase may be used interchangeably.)

An indicator for the sign of the correlation between signals In_1 and In_2 is obtained from the normalized absolute angle of the cross-spectrum. It takes values between 0 and 1, where values close to 0 indicate positive correlation (=phase difference close to zero), values close to 1 indicate negative correlation (=phase difference close to 180 degree) and values close to 0.5 indicate no correlation or a phase difference of 90 degree. To obtain this indicator, the frequency dependent absolute cross spectrum phase is summarized into a single value using a frequency weighted mean.

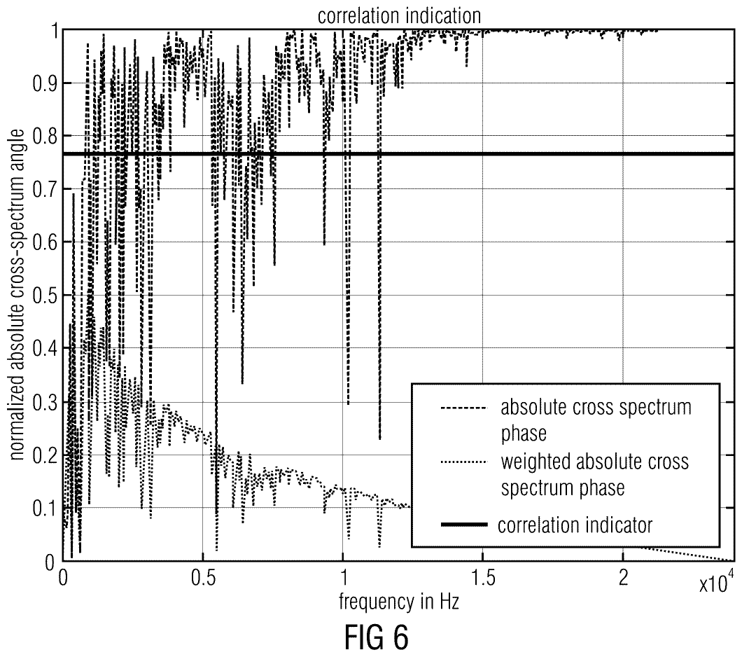

In an advantageous embodiment of the processing illustrated by FIG. 6 the weighting factor is decreasing with increasing frequency.

The correlation indicator (P_{w}) can be calculated as follows.

$${P}_{w} = \frac{{\sum }_{f} P ( f , s ) W ( f , s )}{{\sum }_{f} W ( f , s )}$$

wherein P(f,s) are the absolute normalized cross-spectrum angle, and W(f,s) are the frequency dependent weighting factors.

In embodiments, the signal separation can be adjusted via parameters to define e.g. above which threshold value signal portions are being assigned to the coherent or non-coherent parts. The separation can be parameterized such that the separation decision is not a binary one, but the assignment to coherent and non-coherent parts has a smooth transition.

The separation of coherent and non-coherent signal parts is based on the estimated coherence value for each time-frequency bin.

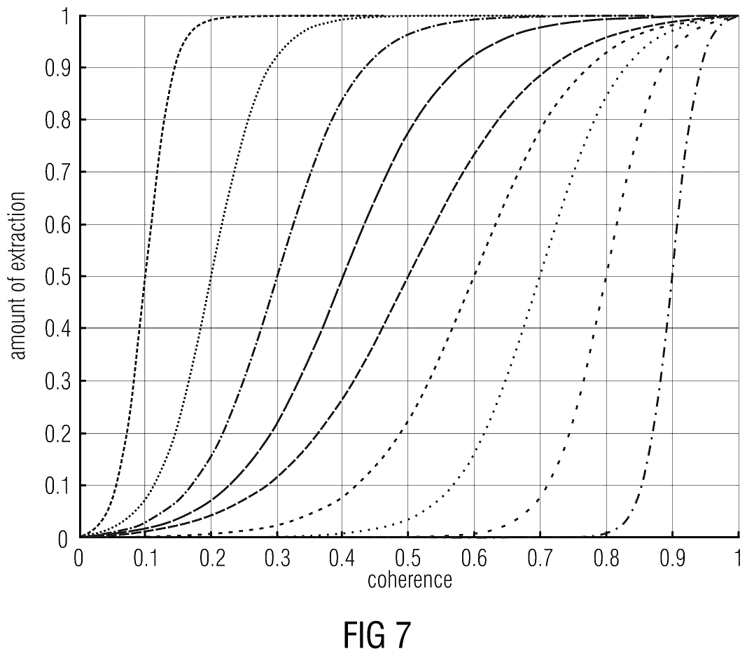

In an advantageous embodiment, a separation function according to the function depicted in FIG. 7 is used.

A threshold value can be set for the coherence, which defines the coherence value at which half of the signal's magnitude (i.e. the specific bin's magnitude) is attributed to the coherent parts, and half of the signal's magnitude is contributing to the non-coherent part. Depending on the set threshold, the smooth transition regions for coherence values closer to 0 or 1 also change their shape. (The threshold cannot be 0 or 1).

$$M = \frac{\frac{1}{1 + {e}^{- s ( {C}_{x y} - {S}_{0} )}} - \frac{1}{1 + {e}^{s {S}_{0}}}}{\frac{1}{1 + {e}^{- s ( 1 - {S}_{0} )}} - \frac{1}{1 + {e}^{s {S}_{0}}}}$$

$$s = \frac{a}{0 \text{.5} - \vert 0.5 - ( 1 - {S}_{0} ) \vert}$$

where S₀ is a frequency-dependent threshold value and a is a factor which adjusts the steepness of the extraction curve. So can be any number greater 0 and smaller than 1, a can be any number greater than 0. (For clarity, the frequency and time indices have been omitted in the above formulae.

The separation function can be different in different frequency regions, i.e. it can be adjusted in a frequency dependent manner. (e.g. So may, e.g. be set to a lower floor value for low frequencies and/or may, e.g. be set to a higher floor value for high frequencies, with a linear transition between the lower floor value and the higher floor value, with a which may, e.g., be set to a value, e.g., between 2 and 15).

The threshold and the specified separation function can be different in different frequency regions, i.e. it can be adjusted in a frequency dependent manner.

In an advantageous embodiment, the frequency dependent threshold is defined differently for low and high frequencies, with a linear transition in between both.

For example at low frequencies, a lower threshold could be used, while for high frequencies a higher threshold could be used so that only very highly correlated signals portions will end up in the coherent part of the separated signal, which will eventually be phase aligned.

In an embodiment, this (frequency dependent) threshold is a parameter that can be tuned based on the specific application scenario.

The resulting factor that is used for the separation of the signal portions into coherent and non-coherent parts can furthermore be smoothed over time to achieve smooth transitions for signals with varying degrees of coherence and to avoid rapid fluctuations in the separation.

In an advantageous embodiment, this smoothing works with different time constants for changes from low coherence to higher coherence (attack time constant) and for changes from regions with high coherence to regions with low coherence (release time).

The attack time and release time are tuning parameters that control the adaptation speed of the separation mask. A short attack time causes the values of the separation mask to increase quickly between two subsequent time frames if a signal contains suddenly appearing coherent content. A short release time causes the values of the separation mask to decrease quickly between two subsequent frames if a coherent signal stops being coherent.

Long attack times and release times cause slower adaptation of the separation mask to changes in the contents.

Different attack and release times may be used for positively correlated signal portions than for negatively correlated signals portions.

Different attack and release times may be applied for signals with positive or negative correlation so that the mask is adjusted adaptively depending on the actual signal content.

In an advantageous embodiment, the sign of the correlation is used to control the attack and release times.

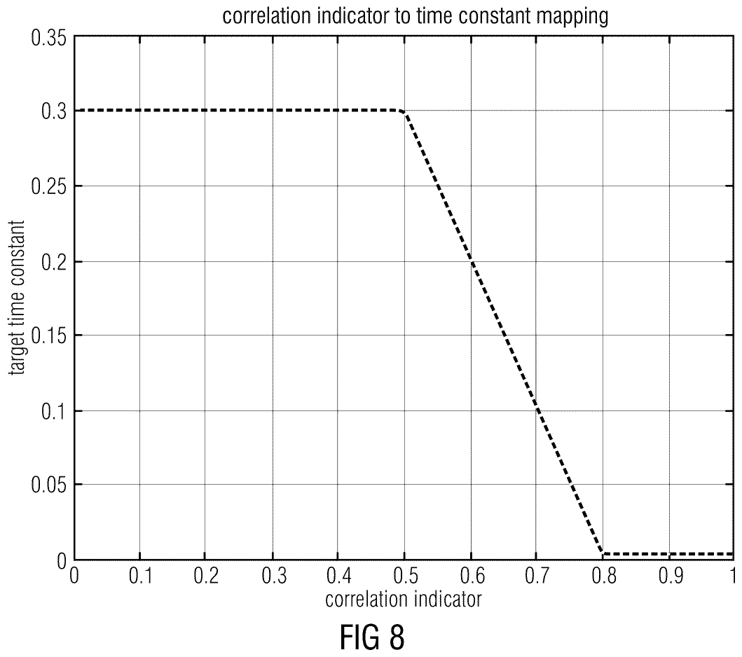

FIG. 8 illustrates a plot which depicts an example mapping between the aforementioned correlation indicator and a correlation adaptive time constant (which could be attack or release time) according to an embodiment. As for this mapping, a short time constant of 10 ms is defined for negatively correlated content with a correlation indicator above 0.8 and a time constant of 300 ms is defined for rather positively correlated content with a correlation indicator below 0.5.

Since the correlation of the signal might change quickly between subsequent frames, also the target attack and release times, which are related to the correlation indicator by the function shown in FIG. 8, can change quickly. It is, however, not desirable to change the attack and release times which are controlling the adaptation speed of the separation mask too quickly between subsequent frames.

Therefore, additional time constants are used to control the adaptation speed of the aforementioned attack and release times. They function in the same way as the previously described attack and release times, except that they are not controlling the adaptation speed of separation mask values but the adaptation speed of the attack time value and the release time value.

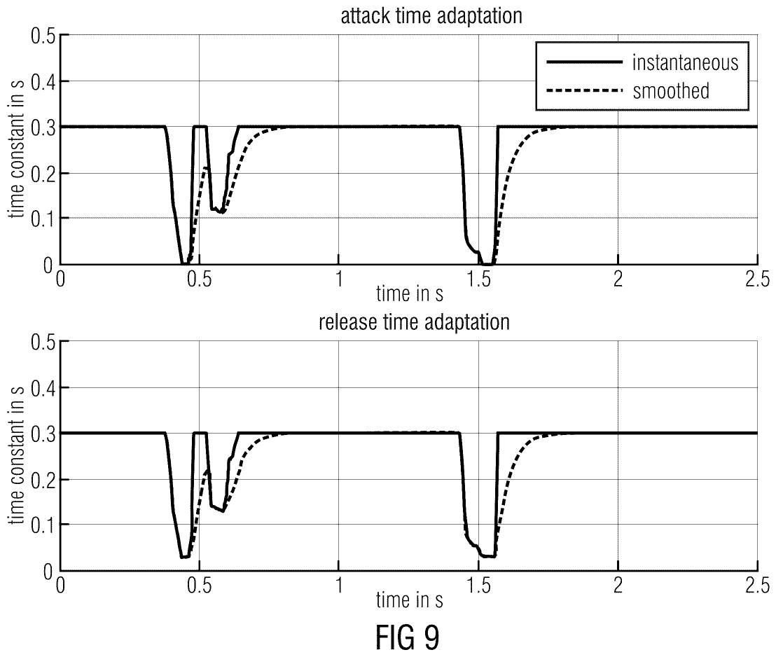

FIG. 9 illustrates an example for a smoothing of the attack and release times according to an embodiment. In particular, FIG. 9 shows the behavior for a shorter attack and a longer release time in the time constant smoothing.

Since it is not desirable to change the attack time and release time of the separation too rapidly the actually applied values are smoothed over time to avoid sudden changes, and the adaptation speed of the attack and release time can be controlled by the smoothing parameters.

Once the signals have been separated in that way, the phases for the coherent signal portions are aligned.

One signal can be chosen as the reference signal (in our examples we chose In_1 as reference. Since only signal parts that are similar in both signals are processed, the actual choice is not of critical importance).

In an advantageous embodiment, the alignment consists in:
For variant 1: copying the phase information of the reference signal to the other signal (i.e. the phase information of the reference signal is used for both signals).
For variant 2: copying and inverting the phase information of the reference signal to the other signal

The non-coherent parts (and the coherent parts which are not fed into the phase alignment) of the signal to be processed remain unchanged.

Since the advantageous way of processing is happening in the time-frequency domain, all parameters of the processing can be set in a frequency dependent way. Such, e.g. the time constant α in the coherence calculation, the coherence threshold, the control of the signal separation time constants, the correlation indicator, etc. could be tuned in a frequency dependent manner depending on the specific application scenario.

Similarly, the whole processing can be performed only in selected frequency bands.

An alternative way of limiting the processing to specific parts of an input would be to apply the processing signal dependent, i.e. to apply it e.g. only on the speech or vocal parts of an input signal.

In an alternative embodiment, the correlation indicator could e.g. be calculated in the time domain (which would correspond to the actual signal correlation). A frequency dependent correlation calculation in the time domain could be realized by the use of filterbank and correlation calculation for the individual bands.

The (frequency dependent) correlation or correlation indicator can be used to extract only parts of the content lying within certain correlation limits, i.e. only parts of the signal lying withing the specified correlation ranges would be separated to be fed to Coh_1 and Coh_2.

In the following, various application scenarios of particular embodiments are presented.

In a known processing path (e.g. in a production or reproduction system), the processing can be applied to signals that are combined at a later stage.

In systems where the processing or reproduction path can change during operation, e.g. since it is adjustable by a user, or adapts itself to certain boundary conditions or it environment, the processing can be applied to the signals that are most likely to be combined at a later stage.

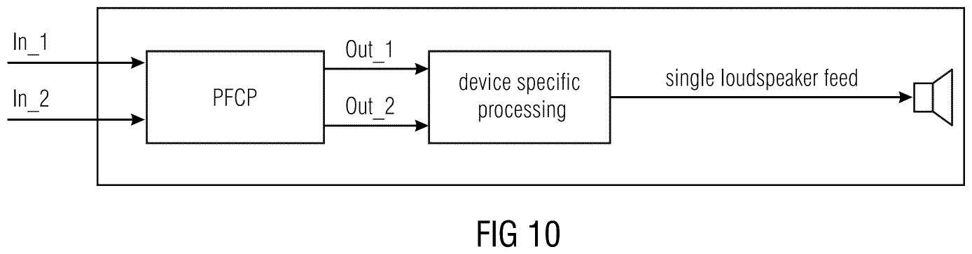

FIG. 10 illustrates an example application according to an embodiment (in FIG. 10, the block labeled PFCP) with a simple smart speaker that has been introduced before.

A specific benefit of applying the described preprocessing on the input signals (e.g. in comparison to applying it as a last step of the Device specific Processing) can be seen from application scenarios that make use of multiple playback devices.

The method can e.g. especially be beneficially applied if the target playback system consists of multiple playback devices. This could e.g. be the case in a multi-room playback scenario where many smart speakers are fed with the same two-channel signal. It is sufficient to apply the processing only once (e.g. in the player device, or in a master device feeding the other devices with the signal).

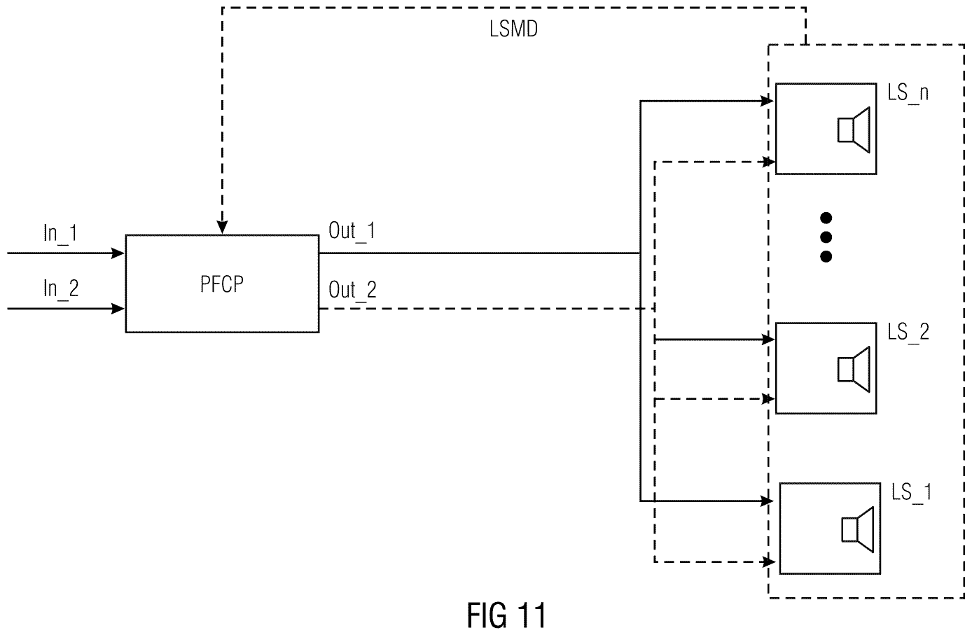

FIG. 11 illustrates such a scenario according to an embodiment, in which an audio signal is sent from a source device (e.g. a media player, or a receiver, etc.) to multiple playback devices (e.g. smart speakers).

These multiple playback devices could be positioned in different rooms or play together in one room.

Such, the preprocessing would only have to be applied once instead of processing it in each individual playback device.

In a system that offers the possibility to gain information about the loudspeaker setup (e.g. types of loudspeakers, position of loudspeakers), this information (LSMD-loudspeaker setup metadata) can be fed back to the processor to steer the actual processing.

This could even be used to switch off or bypass the processing if the actual playback setup is capable of reproducing the originally intended auditory effect when playing back phase-inverted signals.

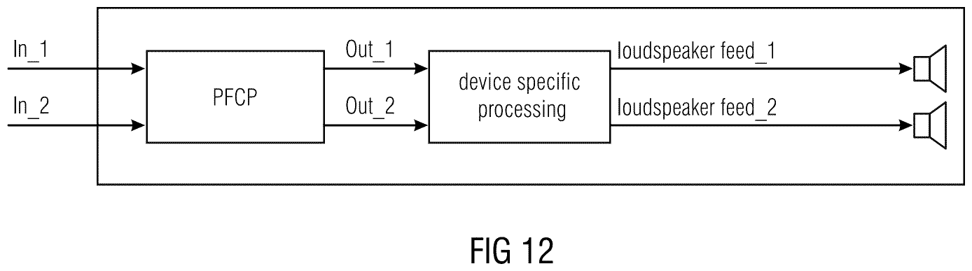

Similarly, in an example device according to an embodiment depicted by FIG. 12 with two loudspeaker drivers in a single enclosure, the frequency selective processing can be adjusted for the specifications and characteristics of this specific device. Depending on the loudspeakers capabilities and the distance between the two loudspeakers, the specific auditory effects of phase inverted signals may be reproduced, while in other frequency ranges they would lead to cancelation of the signal content.

Since the playback device is known in advance, the processing parameters can be tuned or adjusted accordingly.

(Such an adaptation could be done by manual tuning, or based on parameters of the playback system like reproducible frequency range, distance of the loudspeakers to each other, etc.)

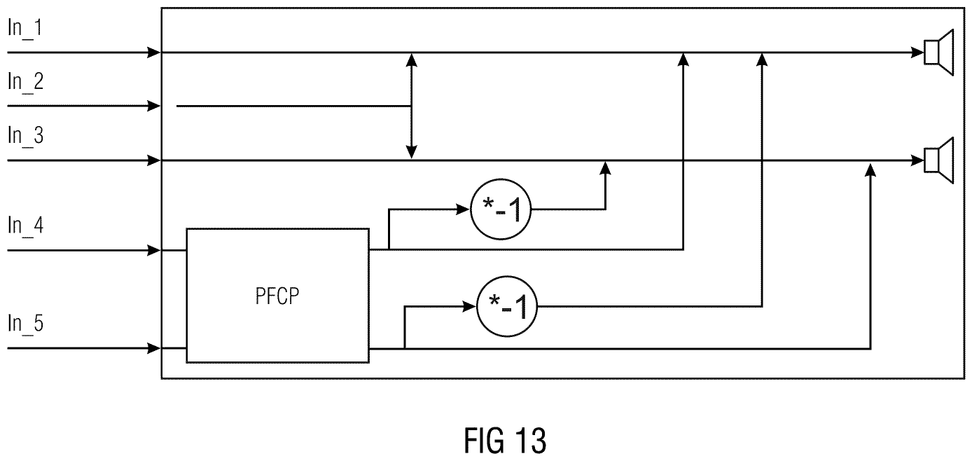

FIG. 13 illustrates an example application of the described processing (Block PFCP) in the soundbar device that has been introduced before according to an embodiment.

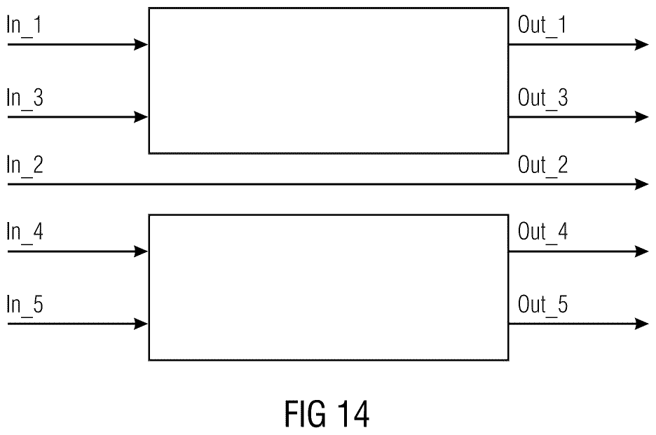

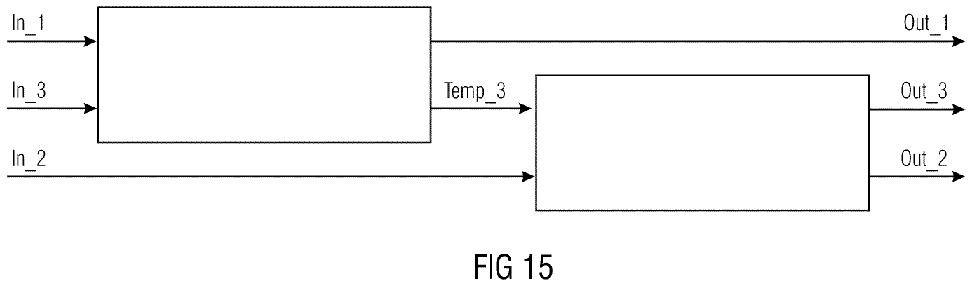

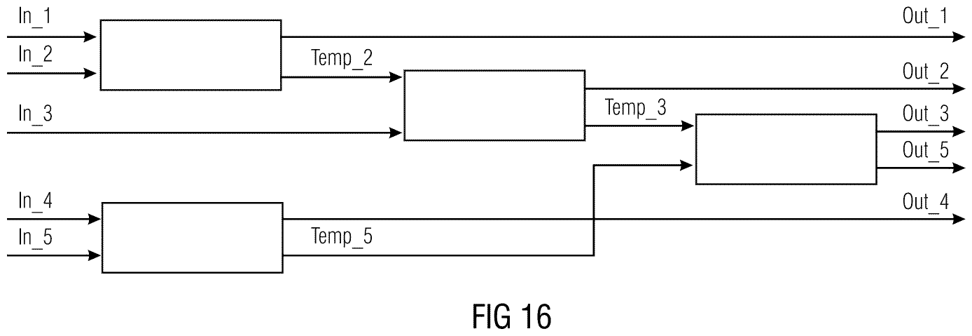

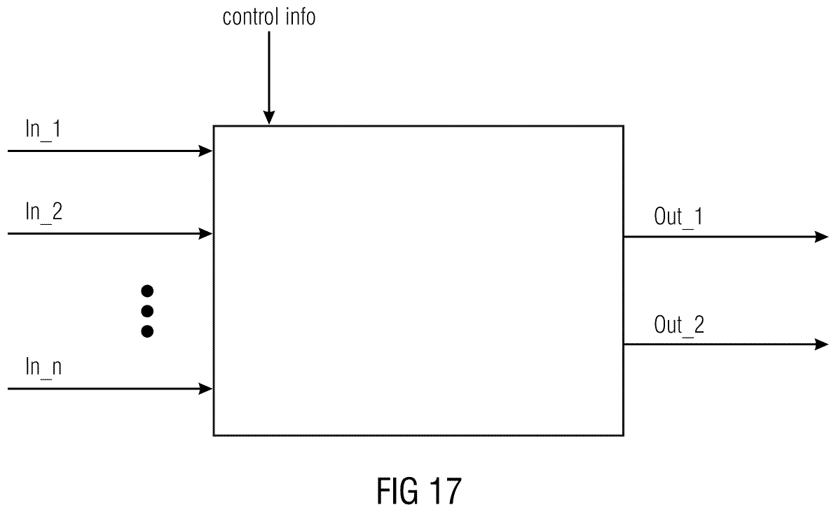

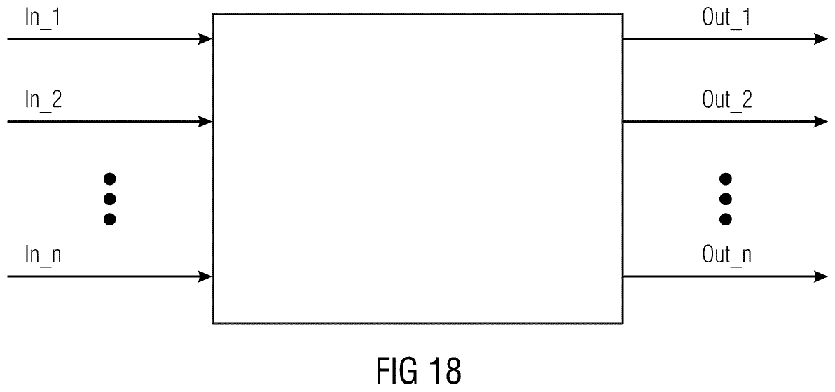

The use of the method for multiple input-signals (e.g.: more than two) can be done:
by applying the processing multiple times, either in a parallel fashion (see FIG. 14), or in a concatenated/sequential fashion (see FIG. 15), or a mixture of both (see FIG. 16)
by extending the processor to multiple inputs and adding means to select, based on selection parameters or control parameters, the two input channels that should be processed (see FIG. 17)
by calculating the coherence and correlation between the multiple channels and different combinations thereof, and modifying the processor such that the phase alignment happens from one channel to a multiple of the other channels (see FIG. 18).

The described method can be used beneficially for numerous applications.

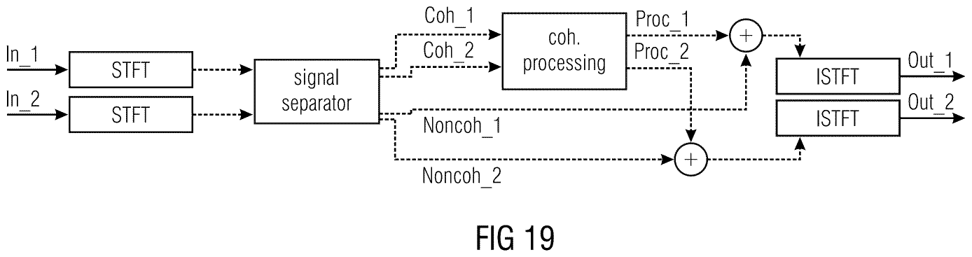

In an embodiment, the application of this power compensation can be decided based on consideration of guidelines or parameters regarding the design, complexity, performance, or quality of the target system. FIG. 19 illustrates the processing without the power compensation.

The separation mask is calculated from the coherence between both input signals. In an alternative embodiment of the processing the separation mask may consider additional information, such as gain and phase differences between both channels. In an advantageous embodiment of the processing only portions of the signal for which phase adjustment is desirable to avoid detrimental effects in subsequent processing steps are extracted.

In some embodiments it may be beneficial to apply the signal separation in a limited frequency range only, meaning that all signal portions outside the specified frequency range end up in the non-coherent part and are such not affected by the further processing.

In an alternative embodiment of the processing only the coherent signal parts with a high degree of positive (or negative) correlation would be processed. In another alternative embodiment of the processing only the coherent signal parts with a high degree of potential cancellation in (phase correct or phase inverted) summation would be processed.

In the alternative embodiments where only parts of the coherent signal portions would be phase aligned, both variants of phase alignment as described before would be possible in the same way.

The calculated coherence values in STFT domain can also be smoothed across frequencies.

In an alternative embodiment the separation/extraction factor can also be smoothed along frequency.

According to a further embodiment, in some cases it is not desirable to feed all of the coherent content into the first signal portion. It is only necessary to adjust the phase of the portions of the signal which would cause detrimental effects in subsequent processing.

E.g. in the case processing signals that are eventually reproduced over a single loudspeaker, these are out-of-phase portions within the coherent signal.

The portions of the (coherent) signals which would not cancel out in a summation can be removed from the separation mask. The cancellation is calculated in the following manner, where Gₓₓ and G_{yy} are the averaged autospectra of the input signals X and Y and G_{z} is the averaged autospectrum of the complex sum of X and Y.

$$Z = X + Y$$

$${Q}_{i} = \sqrt{{G}_{x x}} + \sqrt{{G}_{y y}}$$

$${Q}_{o} = \sqrt{{G}_{z}}$$

$$Z = 10 {log}_{10} ( {Q}_{i}^{2} ) - 10 {log}_{10} ( {Q}_{o}^{2} )$$

The calculated cancellation Z (in dB) for each frequency bin in each frame is translated into a factor N (linear) which is applied to the separation mask M to get a modified separation mask M_{mod}. For low amounts of cancellation the separation mask value is reduced, i.e. less of the signal is phase-aligned.

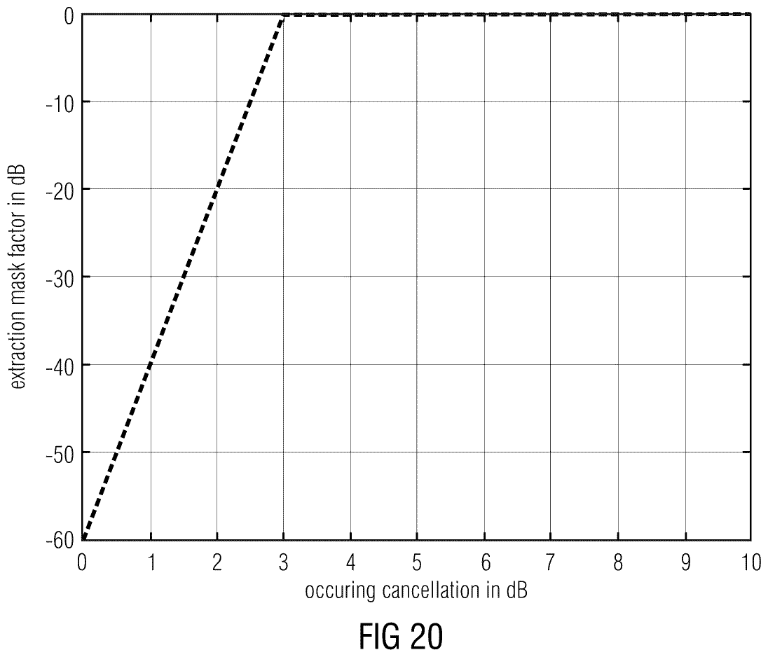

The translation function F could take a shape as shown in FIG. 20, where signals causing cancellations above a certain threshold are not removed from the separation mask and signals causing cancellations below this threshold are increasingly removed from the separation mask.

$$N = F ( Z )$$

$${M}_{m o d} = M \cdot N$$

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1-66. (canceled)

67. An apparatus for audio signal processing, wherein the apparatus comprises:
a signal separator for separating each of at least two audio input signals into a first signal portion and into a second signal portion;
a signal processor for obtaining a phase-aligned signal portion of each of the at least two audio input signals from the first signal portion of each of the at least two audio input signals by modifying the first signal portion of at least one audio input signal of the at least two audio input signals; wherein the signal processor is configured to modify the first signal portion of said at least one audio input signal by phase aligning the first signal portion of said at least one audio input signal with the first signal portion of at least another audio input signal of the at least two audio input signals; and
a combiner for combining the phase-aligned signal portion and the second signal portion of each of the at least two audio input signals to obtain at least two audio output signals.

68. The apparatus according to claim 67,
wherein the signal separator is configured to separate each of the at least two audio input signals into the first signal portion and into the second signal portion depending on a coherence and/or a correlation; or
wherein the signal separator is configured to separate each of the at least two audio input signals into the first signal portion and into the second signal portion depending on a coherence and/or a correlation of the first signal portion and a signal portion of one or more other audio input signals of the at least two audio input signals; or
wherein the signal separator is configured to separate each of at least two audio input signals into the first signal portion and into the second signal portion, such that the first signal portion is coherent with a signal portion of one or more other audio input signals of the at least two audio input signals; or
wherein, to obtain the phase-aligned signal portion of each of the at least two audio input signals, the signal processor is configured to modify the first signal portion of said at least one audio input signal, and is configured to not modify the first signal portion of said at least one other audio input signal; or
wherein, to obtain the phase-aligned signal portion of each of the at least two audio input signals, the signal processor is configured to modify the first signal portion of each of the at least two audio input signals; or
wherein the at least two audio input signals are exactly two audio input signals, wherein said at least one audio input signal is exactly one audio input signal, wherein said at least one other audio input signal is exactly one other audio input signal, and wherein the at least two audio output signals are exactly two audio output signals.

69. The apparatus according to claim 67,
wherein the signal processor is configured to phase align the first signal portion of said at least one audio input signal with the first signal portion of said at least one other audio input signal in the frequency domain.

70. The apparatus according to claim 69,
wherein the signal processor is configured to align a phase of at least one frequency band of the first signal portion of said at least one audio input signal with a phase of said at least one frequency band of the first signal portion of said at least one other audio input signal in the frequency domain; or
wherein the signal processor is configured to align a phase of each of two or more frequency bands of the first signal portion of said at least one audio input signal with a phase of each of said two or more other frequency bands of the first signal portion of said at least one other audio input signal in the frequency domain; or
wherein the apparatus further comprises a time-to-frequency transform unit for transforming the at least two audio input signals, being represented in a time domain, from the time domain to the frequency domain, and wherein the apparatus further comprises a frequency-to-time transform unit for transforming the at least two audio output signals, being represented in the frequency domain, from the frequency domain to the time domain.

71. The apparatus according to claim 67,
wherein the signal processor is configured to phase align the first signal portion of said at least one audio input signal with the first signal portion of said at least one other audio input signal such that in case of a negative correlation of the first signal portion of said at least one audio input signal and the first signal portion of said at least one other audio input signal, the phase-aligned signal portion of said at least one audio input signal and the phase-aligned signal portion of said at least one other audio input signal have a same phase after the phase aligning; or
wherein the signal processor is configured to phase align the first signal portion of said at least one audio input signal with the first signal portion of said at least one other audio input signal such that in case of a positive correlation of the first signal portion of said at least one audio input signal and the first signal portion of said at least one other audio input signal, the phase-aligned signal portion of said at least one audio input signal and the phase-aligned signal portion of said at least one other audio input signal have an inverted phase after the phase aligning; or
wherein the signal processor is configured to phase align the first signal portion of said at least one audio input signal with the first signal portion of said at least one other audio input signal by copying the phase information of the first signal portion of said at least one other audio input signal to the first signal portion of said at least one audio input signal; or
wherein the signal processor is configured to phase align the first signal portion of said at least one audio input signal with the first signal portion of said at least one other audio input signal by copying and inverting the phase information of the first signal portion of said at least one other audio input signal to the first signal portion of said at least one audio input signal; or
wherein the signal processor is configured to phase align the first signal portion of said at least one audio input signal with the first signal portion of said at least one other audio input signal without altering a magnitude of the first signal portion of said at least one audio input signal and without altering a magnitude of the first signal portion of said at least one other audio input signal; or
wherein the second signal portion of each of the at least two audio input signals is unmodified when being combined by the combiner; or
wherein the at least two audio input signals comprise one or more audio channel signals and/or one or more audio object signals and/or one or more Ambisonics signals; or
wherein the apparatus comprises a power compensator such that a total signal energy of the at least two audio output signals corresponds to a total signal energy of the at least two audio input signals, or such that a signal energy of one of the at least two audio output signals corresponds to a signal energy of one of the at least two audio input signals, or such that a signal energy of each of the at least two audio output signals corresponds to a signal energy of one of the at least two audio input signals.

72. The apparatus according to claim 67,
wherein the signal separator is configured to separate each audio input signal of at least two audio input signals into a first signal portion and into a second signal portion by applying a first mask value on a time-frequency bin of said audio input signal to obtain a time-frequency bin of the first signal portion, and by applying a second mask value that depends on the first mask value on said time-frequency bin of said audio input signal to obtain a time-frequency bin of the second signal portion.

73. The apparatus according to claim 71,
wherein the signal separator is configured to apply a same first mask value on two or more time-frequency bins of a same frequency band of said audio input signal to obtain two or more time-frequency bins of the first signal portion for said same frequency band; or
wherein the signal separator is configured to apply a same second mask value on two or more time-frequency bins of a same frequency band of said audio input signal to obtain two or more time-frequency bins of the second signal portion for said same frequency band; or
wherein the signal separator is configured to separate each audio input signal of at least two audio input signals into a first signal portion and into a second signal portion by multiplying the first mask value and said time-frequency bin of said audio input signal to obtain a time-frequency bin of the first signal portion, and by multiplying the second mask value and said time-frequency bin of said audio input signal to obtain a time-frequency bin of the second signal portion, wherein the first mask value exhibits a value v1, with 0≤v1≤1, and wherein the second mask value v2=1−v1; or
wherein the signal separator is configured to separate the coherent signal parts into a first signal portion and into a second signal portion of said audio input signal such that the first signal portion only comprises coherent signal parts of the at least two audio input signals which exhibit a potential cancellation in sum which is greater than a threshold.

74. The apparatus according to claim 67,
wherein the signal separator is configured to separate each audio input signal of at least two audio input signals into a first signal portion and into a second signal portion depending on a coherence for each time-frequency bin of a plurality of time-frequency bins, wherein the coherence is averaged over time.

75. The apparatus according to claim 74,
wherein the signal separator is configured to determine the coherence for each time-frequency bin of the plurality of time-frequency bins depending on an auto-correlation for said time-frequency bin that is averaged over the time, and depending on a cross-correlation for said time-frequency bin that is averaged over time; or
wherein the signal separator is configured to determine a frequency-dependent absolute cross spectrum phase, summarized into a single absolute cross spectrum phase value by a frequency dependent mean.

76. The apparatus according to claim 74,
wherein the signal separator is configured to separate each audio input signal of at least two audio input signals into a first signal portion and into a second signal portion by employing a separation function which depends on the coherence for a time-frequency bin of the plurality of time-frequency bins.

77. The apparatus according to claim 76,
wherein the separation function separates a magnitude of a time-frequency bin into a coherent magnitude portion and into a non-coherent magnitude portion; or
wherein the separation function is frequency-dependent; or
wherein the separation function depends on a signal property of at least one of the at least two audio input signals.

78. The apparatus according to claim 76,
wherein the separation function depends on a threshold value.

79. The apparatus according to claim 78,
wherein the threshold value is frequency dependent, such that the signal separator is configured to assign a greater magnitude portion to the first signal portion exhibiting a lower frequency compared to a magnitude portion assigned to the first signal portion exhibiting a higher frequency for a same coherence; or
wherein the apparatus comprises an interface for setting the threshold value.

80. The apparatus according to claim 67,
wherein the signal separator is configured to smooth the separation of the at least two audio input signals into the first signal portion and into the second signal portion over time.

81. The apparatus according to claim 80,
wherein the signal separator is configured to smooth the separation of the at least two audio input signals over time depending on an attack time which defines an adaptation of a separation mask when a coherence increases and/or depending on a release time which defines an adaptation of the separation mask when the coherence decreases.

82. The apparatus according to claim 67,
wherein the apparatus is configured to only process particular frequency bands of the at least two audio input signals; or
wherein the apparatus is configured to only process particular signal parts of the at least two audio input signals which exhibit particular signal characteristics or which exhibit a particular property; or
wherein the signal separator is configured to determine a correlation indicator in a time domain; or
wherein the signal separator is configured to calculate a frequency-dependent correlation indication in the time domain by employing a filterbank and by conducting correlation calculation for particular bands; or
wherein the apparatus further comprises a device-specific processing stage to generate a single loudspeaker output from the at least two audio output signals; or
wherein the apparatus is configured to feed the at least two audio output signals into each loudspeaker of three or more loudspeakers; or
wherein the apparatus is configured to receive information on a loudspeaker setup, wherein the apparatus is configured to bypass or to not bypass the processing conducted by the signal separator and the signal processor and the combiner using the information on the loudspeaker setup; or
wherein the apparatus is configured to receive information on a loudspeaker setup, wherein the apparatus is configured to bypass or to not bypass the processing in one or more frequency bands conducted by the signal separator and the signal processor and the combiner using the information on the loudspeaker setup; or
wherein the apparatus further comprises a device-specific processing stage to generate two loudspeaker feeds for two loudspeakers from the at least two audio output signals using information on one or more capabilities of the two loudspeakers and/or information on a distance between the two loudspeakers.

83. The apparatus according to claim 67,
wherein the at least two audio input signals are at least three audio input signals; wherein the apparatus is configured to process the at least three audio input signals by applying the processing of the signal separator, of the signal processor and of the combiner two or more times; or
wherein the at least two audio input signals are at least three audio input signals; wherein the apparatus is configured to process the at least three audio input signals by extending the processor to multiple inputs and by employing means to select, depending on selection parameters or control parameters, two audio input signals of the three or more audio input signals that shall be processed; or
wherein the at least two audio input signals are at least three audio input signals; wherein the apparatus is configured to process the at least three audio input signals by calculating a coherence and a correlation between two or more pairs of the at least three signals and/or by calculating different combinations thereof, and the signal processor is configured to conduct phase alignment by using a phase of a first signal portion of one audio input signal of the at least three audio input signals for two or more other audio input signals of the at least three audio input signals.

84. The apparatus according to claim 67,
wherein the signal separator is configured to separate the at least two audio input signals into the first signal portion and into the second signal portion further depending on gain differences and/or phase differences between the at least two signals; or
wherein the signal separator is configured to only separate coherent signal parts of the at least two audio input signals with a degree of positive correlation being greater than a threshold into a first signal portion of the at least two audio input signals; or
wherein the apparatus is configured to only process coherent signal parts of the at least two audio input signals with a degree of negative correlation being smaller than a threshold; or
wherein the apparatus is configured to smooth calculated coherence values across frequencies; or
wherein the apparatus is configured to smooth a separation factor along frequency; or
wherein the first signal portion is a coherent signal portion, and/or wherein the second signal portion is a non-coherent signal portion.

85. A method for audio signal processing, wherein the method comprises:
separating each of at least two audio input signals into a first signal portion and into a second signal portion;
obtaining a phase-aligned signal portion of each of the at least two audio input signals from the first signal portion of each of the at least two audio input signals by modifying the first signal portion of at least one audio input signal of the at least two audio input signals; wherein modifying the first signal portion of said at least one audio input signal is conducted by phase aligning the first signal portion of said at least one audio input signal with the first signal portion of at least another audio input signal of the at least two audio input signals; and
combining the phase-aligned signal portion and the second signal portion of each of the at least two audio input signals to obtain at least two audio output signals.

86. A non-transitory computer-readable medium comprising a computer program for implementing the method of claim 85 when being executed on a computer or signal processor.
